(19) United States
(12) Patent Application Publication
(10) Pub. No.: US 2026/0155773 A1
(43) Pub. Date: Jun. 4, 2026

(54) PHOTOVOLTAIC GREEN ROOFS AND FACADES

(71) Applicant: Green Skin, Saint Paul (FR)

(72) Inventors: Benoît Dumortier, Saint Paul (FR); Stéphane Boudrandi-Saj, Saint Paul (FR)

(21) Appl. No.: 19/119,509

(22) PCT Filed: Sep. 27, 2023
(86) PCT No.: PCT/EP2023/076740

§ 371 Date: Apr. 9, 2025

(30) Foreign Application Priority Data
Oct. 17, 2022 (FR) FR2210686

(51) Int. Cl. H02S 20/30; E04D 11/00; H02S 20/23

(52) U.S. Cl. CPC H02S 20/30; E04D 11/002; H02S 20/23

(57) ABSTRACT

A green roof system includes a support, plant growth modules, and a plurality of bifacial orientable photovoltaic panels arranged above the plant growth modules. Each of the plant growth modules includes a sealing membrane and a multilayer culture complex successively comprising at least a first fibrous synthetic material and a flexible mesh.

### CROSS-REFERENCE TO RELATED APPLICATIONS

This application is a national phase entry under 35 U.S.C. § 371 of International Patent Application PCT/EP2023/076740, filed Sep. 27, 2023, designating the United States of America and published as International Patent Publication WO 2024/083468 A1 on Apr. 25, 2024, which claims the benefit under Article 8 of the Patent Cooperation Treaty of French Patent Application Serial No. FR2210686, filed Oct. 17, 2022.

### TECHNICAL FIELD

The present disclosure concerns the field of value-added roofs and facades, and more particularly green roofs and facades equipped with orientable photovoltaic panels.

### BACKGROUND

One example is the PROOF (Photovoltaic and green ROOF) project run by the Institut National de l'Énergie Solaire (INES), which combines extensive green roofs (TVEs, in French) and photovoltaic panels to deliver a range of benefits:
Incident solar energy dissipated by a green roof in summer, mainly in the form of latent heat flux, reduces local air temperature and provides the right conditions for increasing the electrical output of a photovoltaic panel;
An extensive green roof with a structure capable of storing rainwater promotes evapotranspiration flows and can therefore further improve the panel's performance;
On a building scale, the overall energy balance (energy production/consumption in use+embodied energy) is more advantageous for a combined system than for a standard bare or green roof;
Compared with a conventional roof configuration, a combined system provides additional ecosystem services that can be assessed and quantified on a neighborhood scale.

The combination of a green roof and solar panels improves energy performance: The vegetation captures dust and particles, so they don't end up on the solar panels. As an added bonus, evapotranspiration from the plants keeps the air cooler, helping to cool the solar panels. This means they absorb less heat, for greater efficiency. The combination of vegetation and solar equipment increases energy production while improving building insulation.

In Sydney, for example, a difference of almost 20 degrees Celsius was observed between a solar surface and a hybrid green/solar panel surface.

The combination of a green roof and directional solar panels also protects the vegetation from direct solar radiation, as the panels cast a shadow between the green roof and the sun. This shaded protection limits evapotranspiration flows and helps save on irrigation-related water consumption.

Patent SE414804 describes outdoor building roofs intended to be overcome by vegetation and comprising an underlying, water-impermeable layer and a layer of material above which plants, in particular, grass and the like, can grow, wherein the underlying, water-impermeable layer consists of corrugated sheets arranged with their grooves extending in the direction inclined to the roof surface, and the cultivable layer consists of a plurality of separate sheets of a material in which plants can grow, which sheets are placed next to each other and at a distance from each other at least in the direction inclined to the roof surface on the underlying corrugated sheets and are held thereon by means of the same holding means.

Patent KR101572859B1 describes a photovoltaic installation support, and more particularly, one for installing a photovoltaic installation capable of producing solar energy representative among renewable energies in any location and minimizing the installation of the structure used therein.

Patent KR101572859 describes a hybrid greening system for the double roof that is installed on top of the double roof to improve the energy efficiency of the building on which the double roof is installed and to reduce rainwater runoff during rainy weather. A vegetation unit having a partition wall and having an upper surface formed therein and installed in the roof plate.

Patent KR20130142977 describes a solar cell module system enabling a solar cell to be stably installed in a roof.

Utility model CN204392150 describes a photovoltaic module with a roof without a photovoltaic guide rail support, wherein it comprises: a photovoltaic module connector, is connected to the photovoltaic module; the clamping element, is connected to the roof, with a rotation between the photovoltaic module connector and the clamping element.

The solutions of the prior art have several drawbacks. Firstly, they add a significant load to the roof and building structure, making the solution impractical for many buildings of insufficient strength.

Prior art solutions also degrade rapidly, as solar panels create shading that is unfavorable to plant growth.

Finally, the wind load of these prior art solutions is significant, and in areas with severe atmospheric conditions (strong winds, storms, cyclones), these solutions are not suitable.

Prior art solutions limit the optimal exposure time to solar radiation, as the photovoltaic panels are arranged in a fixed, immobile manner.

### BRIEF SUMMARY

In order to remedy the drawbacks of the prior art, the present disclosure relates, in its most general sense, to a green roof system that includes:
a. a support formed by an assembly of folded metal sheets;
b. green modules, each comprising a sealing membrane and a multilayer culture complex successively comprising at least a first fibrous synthetic material and a flexible mesh; and
c. a plurality of orientable photovoltaic panels.

### BRIEF DESCRIPTION OF THE DRAWINGS

The present disclosure will be better understood on reading the following description, which concerns a non-limiting exemplary embodiment that is shown by the appended drawings, in which:

FIG. 1 shows a three-quarter perspective view of a system according to the present disclosure; and

FIG. 2 shows a sectional view of a system according to the present disclosure.

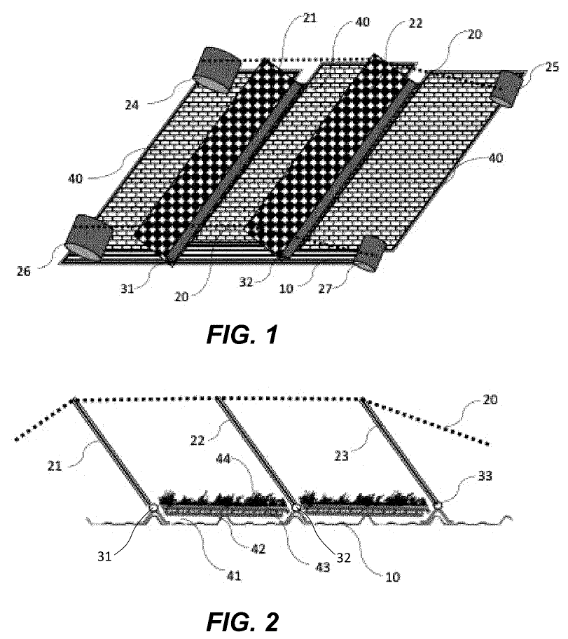

### DETAILED DESCRIPTION

The present disclosure is based on a modular system for fitting out a roof, in particular, a flat roof with no limit to inclination or a flat roof, consisting in laying a support formed by plates of folded metal sheets (10) or any other material (concrete, zinc, slate, wood, etc.), for example, roofing or cladding sheets with parallel ribs. Such sheets are commonly used to clad buildings, whether for roofing or facades. Sheets equipped with identical, adjacent ribs are known to exist. Such uniqueness means that a plurality of sheets can be stacked, facilitating storage and transport. On the other hand, this implies transporting and/or storing sheets of a given type, thus creating a uniform building cladding, at least in terms of the configuration of the sheet ribs.

The term “ribbed” is to be understood here as designating a relief, positive or negative, i.e., convex or concave on the sheet metal. This relief is at a different altitude from the average plane of the sheet. The shape, number and/or distribution of ribs on the sheet are variable. The ribs run parallel to each other. The ribs are identical on the same sheet or form a repeating pattern on each sheet.

The system further comprises photovoltaic panels (21, 22, 23) positioned at least partially above the green areas so as to benefit from cooling by the plants (44), improving photoconversion performance, but also shading the plants (44) to protect them from direct solar radiation.

These photovoltaic panels (21, 22, 23) are advantageously articulated with respect to transverse axes (31 to 33) forming hinges with respect to the support (10), to enable the orientation of the photovoltaic panels (21 to 23) to be adjusted.

The shafts (31 to 33) are connected to the support (10) by angle brackets, for example, which are fastened to the support ribs.

The photovoltaic panels (21 to 23) can be folded flat, parallel to the plane of the support (10), or erected to face the sun, the panels being angularly displaced to keep them parallel to one another. The actuation of the panels (21 to 23) is controlled by a drive system consisting either of motorized hinges or bearings on which the photovoltaic panels rest, or of belts or chains (20) that are driven by motors (24 to 27) and fixed to the top edge of the photovoltaic panels (21 to 23), or by a mechanism similar to that of a bioclimatic pergola, wherein the photovoltaic panels replace the pergola slats so that their positioning based on the position of the sun enables the sun to be partially reflected onto the rear face of the adjacent bifacial PV panel, and so on for each panel.

When the panels are tilted down, they reduce the wind load and protect plants (44), especially during tropical storms.

Finally, the system comprises green modules, for example, of the type described in patent EP3755140. This module comprises a base (41) that rests on the support (10). This rigid, watertight base (41) is completed by a multilayer culture complex successively comprising at least a first synthetic fibrous material (42) and a flexible mesh (43), and optionally a second synthetic fibrous material.

These green modules (40) are inserted between the hinges (31 to 33) of the photovoltaic panels (21 to 23).

When electricity is being generated, the motors (24 to 27) switch the photovoltaic panels (21 to 23) into active position, facing the sun, with an orientation that can change to follow the sun's path.

Outside these periods, the photovoltaic panels (21 to 23) can either be tilted horizontally to reduce the wind load and protect the green modules (40), or placed in a position that allows the sun to illuminate the green modules (40).

The green modules (40) may further comprise an irrigation system controlled by a pump powered by a battery recharged by the photovoltaic panels (21 to 23).

The above description relates to photovoltaic panels (21 to 23) that may be fixed and inclined at an angle adapted to expose the largest surface area perpendicularly to the direction of the sun, allowing them to benefit from plant cooling and forming an inclined screen limiting the wind load. Preferably, they can be tilted down by pivoting about an axis provided in the lower part of the photovoltaic panels (21 to 23) so that, in the event of bad weather or tornadoes, they can be placed horizontally to reduce the wind load and provide plant protection. The photovoltaic panels (21 to 23) can also be hinged about a central or upper axis to hold them in an inclined position.

Variant: bifacial panels

In one embodiment, the panels are of the bifacial type, i.e., they feature photovoltaic cells on both sides, in order to exploit indirect sunlight (reflection of solar radiation on a neighboring panel, albedo, etc.).

1. A green roof system, comprising:
a support;
green modules each comprising a sealing membrane and a multilayer culture complex successively comprising at least a first fibrous synthetic material and a flexible mesh; and
a plurality of orientable bifacial photovoltaic panels arranged above the green modules.

2. The green roof system of claim 1, wherein each of the orientable photovoltaic panels is articulated to tilt between a position parallel to the support, and a position facing the sun.

3. The green roof system of claim 1, wherein each of the photovoltaic panels is hinged about an axis for tilting relative to a lower edge of the respective photovoltaic panel.

4. The green roof system of claim 1, further comprising a belt or chain driven by a motor and fixed to the upper edge of the photovoltaic panels, the belt or chain and the motor configured to drive rotation of each of the orientable photovoltaic panels between a position parallel to the support and a position oriented toward the sun.

5. The green roof system of claim 1, further comprising a drive system including motorized hinges or bearings on which the photovoltaic panels rest, the drive system configured to rotate each of the orientable photovoltaic panels between a position parallel to the support, and a position oriented toward the sun.

6. The green roof system of claim 1, further comprising profiles arranged transversely on the support, the profiles comprising a hinge for articulating one of the photovoltaic panels, the profiles separating two consecutive green modules.

7. The green roof system of claim 1, wherein all of the photovoltaic panels of the green roof system are bifacial photovoltaic panels.
